(19) United States
(12) Patent Application Publication
(10) Pub. No.: US 2005/0074519 A1
(43) Pub. Date: Apr. 7, 2005

(54) Method for the production of natural botanical extracts

(75) Inventors: Daniel D. Bartnick, Indianapolis, IN (US); Charles Mark Mohler, Indianapolis, IN (US); Thomas H. Giel, Carmel, IN (US)

Correspondence Address: FOLEY & LARDNER, 150 EAST GILMAN STREET, P.O. BOX 1497, MADISON, WI, 53701-1497, US

(73) Assignee: Sensient Flavors Inc.

(21) Appl. No.: 10/677,138

(22) Filed: Oct. 1, 2003

(51) Int. Cl. A23K 1/00

(52) U.S. Cl. 426/49

(57) ABSTRACT

Methods for producing natural botanical extracts, such as natural vanilla extracts, with low processing times and high efficiencies are provided. The methods include a high temperature extraction step and, optionally, an enzymatic treatment step. The natural vanilla extracts or other botanical extracts produced by the methods may provide the same degree of flavoring at lower concentrations than conventionally produced natural extracts.

### BACKGROUND

Vanilla is one of the most universally used flavors in the food, pharmaceutical and cosmetic industries. Traditionally vanilla flavorings are extracted from the matured beans of luminous celadon-coloured orchids, Vanilla plantiforia. The distinctive flavor and aroma comes mainly from the phenolic compound vanillin and other aromatic compounds, which typically make up less than 2% of the cured vanilla bean.

Vanilla plants were cultivated by the Aztecs, who used it to flavor their cocoa based drink, xocolati. Considered an aphrodisiac, it was so rare that it was reserved for royalty. Natural vanilla is in relatively short supply and is commonly produced by a long and laborious process. Consequently, the price of natural vanilla extracts tends to be very high. The orchid blossoms open only once a year and must be pollinated by hand. The vanilla beans then take 8 to 12 months to mature and must be hand picked. The mature green beans do not have the characteristic flavor or aroma that is produced by ‘curing’ the bean. The curing process can take between 5 weeks and 5 months. First the beans are ‘killed’ by heat (e.g. 20 seconds in boiling water or 48 hours in an oven) or freezing. Then they are wrapped in blankets, heated in the sun and allowed to sweat followed by drying and conditioning. During this process enzymes naturally present in the beans (glycosidases, proteases and oxidases) ferment the beans, which shrink by up to 400% and turn their characteristic brown colour. The best grades of beans develop a visible white coating of vanillin. There are a number of types of beans which are commonly employed in vanilla extract production. Bourbon Madagascar vanilla beans are rich, sweet and the thinnest type of vanilla bean. About 75% of the world's vanilla beans come from Madagascar. Mexican vanilla beans have a smooth rich flavor. Tahitian vanilla beans are intensely aromatic, though not as flavorful as the other varieties.

Methods for the production of vanilla flavoring vary considerably around the world and are regulated differently in countries such as the U.S.A., Great Britain and France. Vanilla powder is made by grinding dried vanilla beans to a powder and combining the powder with other food additives. The flavor from vanilla powder does not evaporate when heated as readily as vanilla extract making it useful for baked goods. Vanilla powders may contain blending agents such as sugar and anti-caking ingredients such as calcium silicate.

Vanillin, a major component in artificial (imitation) vanilla is often produced by a chemical process that converts by-products (such as wood pulp from the paper industry) into vanillin. Artificial vanilla lacks many of the flavor components extracted from vanilla beans and often has a harsh quality that may leave an aftertaste. Artificial vanilla is usually less than half the cost of natural vanilla.

Vanilla extract is the most common form of natural vanilla flavoring used. It is typically made by macerating chopped beans in an alcohol-water solution. The mixture may be aged for several months to produce a clear brown liquid with a strong vanilla flavor and fragrance. Heating the mixture may speedup the process but this may cause some of the more volatile flavor components to be lost, altering the flavor. A variety of manufacturers utilize a slower ‘cold’ extraction process using recirculation of the menstrum over the beans to minimize loss of volatile compounds. To meet US FDA regulations, a ‘vanilla extract’ must contain at least the sapid and odorous principles extracted from one unit weight (13.35 ounces beans, at a maximum moisture content of 25% by weight, per gallon of solvent) of vanilla beans by an aqueous alcohol solution of not less than 35% ethyl alcohol. Commercially available double and triple strength vanilla extracts are usually based on multiples of the legal minimum unit weights—e.g., a two-fold extract is extracted from 26.7 ounces of vanilla beans per gallon of solvent. In some instances, vanilla extract may also contain food additives such as glycerin, propylene glycol, sugar (e.g., dextrose) and/or corn syrup.

Vanilla extracts are commonly produced through a percolation method using ethanol to extract the flavor components from ground vanilla beans at moderate temperatures and atmospheric pressure. This process, although effective, is very time consuming, often requiring an incubation time of 48 hours or longer. Because there are relatively few sources for vanilla beans, the price of the beans may be affected dramatically by supply shortages. In light of this, a method of producing a natural vanilla extract that increases production, reduces processing costs and/or provides a stronger vanilla flavoring would be quite attractive to the flavoring industry.

### SUMMARY

Methods for producing high quality extracts from natural botanical materials, such as natural vanilla extracts, are provided herein. The present methods often have relatively short processing times. By substantially reducing the amount of time required for production of the extract, plant capacity can be increased and processing costs are lowered, without sacrificing flavor. In fact, the natural botanical extracts, e.g., natural vanilla extracts, provided herein can often provide comparable flavor characteristics when used in lower quantities than corresponding conventionally produced natural extracts. The methods provided herein may use combinations of high temperatures, high pressures and/or enzyme treatment to enhance the production of natural extracts. In some embodiments, the combined processing time for the enzymatic treatment and the extraction may require no more than about 10 hours. In some embodiments, e.g., those relating to the production of natural vanilla extracts, the overall process (enzyme treatment and extraction) may be completed even more rapidly, e.g., the combination of enzymatic treatment and extraction may be completed is no more than about 10 hours and, in some instances, may be completed in 5 hours or less.

The present methods may be used to produce natural flavor extracts from a variety of botanical materials. While the present methods are illustrated herein by reference to descriptions of the production of natural vanilla extracts, the methods can also be used to produce extracts of other botanical materials such as cocoa beans, tea leaves, coffee beans and carob beans.

In one embodiment of the method, a high temperature extraction is carried out by contacting cured vanilla beans with an alcohol solution, e.g., an aqueous alcohol solvent, as a solvent at high temperatures. The alcohol solution desirably contains an alcohol which is miscible with water in the proportions employed. More suitably, the alcohol is an alkanol having no more than 4 carbon atoms (or a mixture thereof). Aqueous alcohol solvents which include ethanol, isopropanol or a mixture thereof are commonly employed. Generally, the extraction temperature will be at least about 170° F. (circa 82° C.). Extraction temperatures of about 180° F. (circa 82° C.) to 250° F. (circa 121° C.) are commonly employed in the present methods.

The extraction is desirably, but not necessarily, carried out by agitating a slurry which includes the comminuted, cured vanilla beans and an aqueous alcohol solvent in a sealed reactor to produce a primary extract. Typically the extraction temperature will range from about 170 to 250° F. and the extraction pressure in the sealed reactor will be at least about 10 psig, although in some instances it may be considerably higher. Ethanol is an example of a suitable alcohol for use in the aqueous alcohol solvent and the ethanol content in the solvent will be desirably at least about 30 vol. %. For example, the ethanol content may range from about 30 to 65 vol. %.

The high temperature extraction may optionally be preceded by enzymatic digestion of the vanilla beans, typically conducted at a somewhat lower temperature. The enzymatic treatment and/or the extraction step may be conducted in a sealed reactor. Suitable enzymes include those with glycosidase activity. As used herein “glycosidase activity” refers to the capability of a hydrolase enzyme to attack glycosidic bonds in carbohydrates and glycoproteins. For the purposes of this disclosure a glycosidic bond refers to the bond between the anomeric carbon of a carbohydrate and another group. The process of vanilla extraction may be enhanced by conducting the enzymatic digestion at elevated pressures. It is believed that the use of elevated pressure during the digestion step may force the enzyme deeper into the vanilla fiber, maximizing the contact of the enzymes with the entire vanilla matrix. The use of elevated pressures and a sealed reactor can reduce the opportunity for the loss of volatile compounds that can occur under ambient pressure conditions.

The processing temperature during the enzymatic digestion should be maintained below the temperature at which the enzymes begin to denature. Typically, the enzymatic digestion process may be carried out at a temperature of at least about 70° F., but desirably no greater than about 150° F. Exposure to relatively high temperatures can lead to denaturation of the enzyme material and loss of activity. Temperatures of about 100° to 180° F. are generally quite suitable for carrying out the enzyme digestion.

The minimum processing pressures in the reactor during the enzymatic treatment and extraction steps will be dictated by the vapor pressures of the solvents at the processing temperatures. However, the reactor pressures may advantageously be further increased by pressurizing the reactor with a gas, e.g., with a non-reactive gas, such as N₂ or argon. In a typical embodiment, the pressure in the reactor for the extraction step will be at least about 10 psig. However, the pressure may also be increased, for either or both steps, to pressures of 60 psig, or even greater.

The pH of the liquid medium (aqueous medium for the enzyme treatment and the extraction solvent) is normally not controlled during the present process. For example, an aqueous medium (such as water or an aqueous alcohol solution) may initially have a pH that is slightly acidic. After initial contact with the botanical material, the aqueous medium is commonly slightly acidic, e.g., has a pH of about 4.5 to 6.0. For example, during the processing of cured vanilla beans, the pH of the aqueous medium during the enzyme treatment is often about 5.0 to 5.5. This pH of the resulting aqueous solvent which is commonly produced by adding an alcohol, such as ethanol, to provide the solvent for the extraction step is generally in a similar range, both before and after the extraction step.

The extraction and optional enzymatic treatment steps described above yield a primary vanilla extract. Depending on the desired level of vanilla flavor in the final product, the primary extract may be concentrated by removing (e.g., via evaporation) some of the alcohol solution. Alternatively, additional solvent (e.g., water and/or alcohol) may be added to the primary extract to produce a more dilute vanilla composition.

### DETAILED DESCRIPTION

Methods for producing natural vanilla extracts and other botanical extracts are provided. The methods can substantially reduce the processing time required to obtain the natural extracts. Natural vanilla extracts and other natural extracts produced by the present processes are often capable of producing food products having the same degree of flavoring when used in lower quantities than corresponding conventionally produced natural extracts. Thus, the present methods may simultaneously increase production and lower processing costs.

The advantages realized by the present methods stem, at least in part, from the high temperatures used during the extraction of the flavoring agents from botanical materials, such as cured vanilla beans. This extraction is accomplished by incubating vanilla beans in an alcohol solution at elevated temperatures for a time sufficient to release the flavoring agents. The extraction may be carried out in any suitable reactor. The extraction is commonly carried out on fermented vanilla beans. As used herein, fermented vanilla beans are beans (“cured vanilla beans”) that have been allowed to dry, typically in the sun, for a time sufficient for the enzymes naturally present to ferment the beans. As such, fermented vanilla beans may be distinguished from “green” vanilla beans, i.e., beans which have not subjected to a curing process.

The alcohol solution used in the extraction is desirably a mixture of ethanol and water. Ethanol is a favored alcohol because it is approved by the U.S. Food and Drug Administration for use in food grade vanilla extracts. However, other alcohols, such as isopropanol, may be used. These other alcohols should be removed subsequently if a food grade product is desired in the U.S. The concentration of the alcohol solution may vary, however it is generally desirable to carry out the extraction in an alcohol solution having an alcohol concentration of at least about 30 vol. %. Commonly, the alcohol solution is an aqueous alcohol solution which contains about 30 to 80 vol. % alcohol, e.g., aqueous ethanol solutions which include about 30 to 65 vol. % ethanol or 40 to 65 vol. % ethanol. The alcohol concentration may be adjusted during the extraction process by introducing additional alcohol solution and/or water into the reactor.

The extraction may advantageously be carried out at elevated temperatures. In some embodiments, the temperature of the reactor contents during the extraction step is at least about 170° F. This includes embodiments where the temperature of the reactor contents during the extraction step is at least about 190° F., and further includes embodiments where the temperature of the reactor contents during the extraction step is at least about 200° F. Extraction temperatures of about 190 to 240° F. are commonly quite suitable. The extraction step is commonly carried out by introducing the solvent into the reactor containing a botanical material, such as cured vanilla beans, under ambient conditions. The reactor is then sealed and pressure is generated within the reactor by heating the contents. If the reactor is sealed, the minimum pressure during the extraction step will depend on the vapor pressure of the alcohol solvent, which is influenced by the temperature in the reactor. Pressures of about 10 to 60 psig can commonly be attained by heating the aqueous alcohol solution in a sealed reactor at temperatures of about 180 to 250° F. For example, when an ethanol solution is used at temperatures of 180 to 210° F. in a sealed reactor, the extraction pressure will typically range from about 15 psig to about 30 psig. The use of elevated extraction temperatures reduces the extraction time considerably compared to vanilla extractions carried out according to conventional percolation methods. In some instances, the extraction step may take no more than about 10 hours and in some cases, no more than about 5 hours. This includes embodiments where the extraction step takes no more than about 3 hours and further includes embodiments where the extraction step takes about 2 hours. For the purposes of this disclosure, the duration of the extraction step (i.e. the extraction time) is the total time that the vanilla beans in the alcohol solvent are exposed to elevated temperatures in a sealed vessel.

During the extraction step, a slurry of the botanical material and aqueous alcohol solvent may be agitated, typically either in a regular or continuous manner. For example, the slurry may be continuously agitated by stirring the slurry with a paddle or plow within the reactor. This can enhance the interaction and contact between the solvent and solid botanical material and may aid in breaking down the particles of the solid into smaller particles.

The methods provided herein may optionally include an enzymatic treatment step prior to the extraction step. When the enzymatic treatment step is included, the cured vanilla pods and a suitable enzymatic material are placed together with an aqueous medium in a sealed reactor. The enzymatic material generally contains one or more enzymes having glycosidase activity, such that the material is capable of at least partially breaking down the fiber matrix of the botanical material, such as beans. Desirable glycosidase activities include cellulase activity, hemicellulase activity, xylanase activity, pectinase activity, and/or β-glycosidase activity. The enzyme material commonly includes glucosidase activity, and in particular β-glucosidase activity, which can aid in breaking down any glucovanillin (4-(β-D-glucopyranosyloxy)-3-methoxybenzaldehyde) still present in the cured vanilla beans to vanillin or related compounds. Suitable commercially available enzymatic materials include, but are not limited to, Depol 40L enzyme material from Biocatalysts Limited, Wales UK and Crystalzyme Concord enzyme material from Valley Research, Inc., South Bend, Ind. In certain embodiments of the present method, enzyme materials which include cellulase activity, hemicellulase activity, pectinase activity and glucosidase activity may be particularly suitable. In other embodiments, the enzyme material may include cellulase activity, xylanase activity, pectinase activity, and β-glucosidase activity.

In order to maintain the optimum activity of the enzyme material, the solvent medium employed for the enzyme treatment desirably contains no more than 10 vol. % alcohol; commonly no more than 5 vol. % alcohol. In many instances, it is preferable to conduct the enzyme treatment in an aqueous medium that is substantially free of alcohol, i.e., contains no more than about 1.0 vol. % alcohol.

While botanical materials may be used in unaltered forms as starting materials for the present processes, the botanical material is commonly comminuted prior to the enzyme treatment and/or extraction. This can enhance the efficiency of the operations. For example, when the present process is used to produce a vanilla extract from cured vanilla beans, the beans are typically comminuted into pieces, either prior to the enzyme treatment/extraction or during the initial stages of the process. Comminuting the botanical material increases it surface area and can enhance the efficiency of the extraction process. For example, when processing vanilla beans according to the present methods, it is generally advantageous to break the beans into smaller pieces while avoiding breaking the solid material down into a finer material which in capable of absorbing substantial quantities of extraction liquid. Vanilla beans are suitably chopped to provide material having an average particle size of about ⅛ to 1.5 inch. This includes embodiments where the vanilla beans have an average particle size of about ⅛ to ¾ inch and further includes embodiments where the vanilla beans have an average particle size of about ⅛ to 3/8 inch. The vanilla beans may be chopped or ground prior to processing or, in some instances, the beans may be comminuted by the processing conditions, e.g., during the initial stages of the enzymatic treatment or the extraction. This may be accomplished by carrying these operations in a reactor equipped with a suitable mixing plow and/or chopping blade.

During the enzyme treatment, the slurry of botanical material and solvent medium is agitated typically either in a regular or continuous manner. For example, the slurry may be continuously agitated by stirring the slurry with a paddle or plow within the reactor. This can both enhance the interaction and contact between the solvent and solid botanical material and aid in breaking down the particles of the solid into smaller particles.

In some embodiments, the enzyme treatment may be carried out at elevated pressures, e.g., pressures of at least about 60 psig or higher. Without limiting the present method, it is believed that this may force the enzymes deeper into the beans, expediting the break down of the fiber matrix. The reactor may be pressurized with a non-reactive gas, such as nitrogen or a rare gas, to a pressure of at least about 60 psig. This includes embodiments where the reactor is pressurized to at least about 70 psig, further includes embodiments where the reactor is pressurized to at least about 80 psig and still further includes embodiments where the reactor is pressurized to about 100 psig or higher.

The temperature in the reactor may be elevated above room temperature, however, it should generally remain below the temperature at which significant denaturation of the enzymes occurs. Thus, the maximum temperature for the enzymatic treatment will depend on the nature of the enzyme material being employed. Typically, however, enzymatic treatment will take place at a temperature of no more than about 180° F. (roughly 82° C.) and more typically at a temperature from about 100 to 140° F. (circa 38 to 60° C.). The enzyme treatment is desirably continued for a period of time sufficient to at least partially break down the fiber matrix of the beans. Generally, the enzyme treatment lasts no more than about 15 hours. This includes methods where the enzyme treatment lasts no more than about 10 hours. For example, the enzyme treatment may last from about 0.25 to 5 hours, commonly at a temperature of about 120 to 140° F. (circa 50 to 60° C.). Treatment times of about 0.5 to 2 hours at such temperatures is often quite suitable for enhancing the efficacy of the subsequent extraction step.

Once a primary vanilla extract has been produced using the extraction step with or without the enzymatic treatment step described above, the liquid contents of the reactor may be removed from the reactor through a filter or sieve in order to separate the remaining solids. This may be accomplished by a simple gravity filtration. In some embodiments, the removal of the liquid extract from the solids may be assisted by flushing the residual solids with additional portion of solvent. The flush may then be used as a solvent in a subsequent extraction step. Alternatively, the flush may be combined with the filtrate for use as a solvent in a subsequent extraction step. In other embodiments, the liquid extract may be forced out of the reactor by introducing a pressurized gas, such as air or nitrogen, to the reactor or by applying a partial vacuum to the outlet side of the filter to draw the liquid away from the residual solid material. When it is desirable to minimize the loss of volatile flavor components in the extract, gravity filtration of the liquid extract from the extraction slurry followed by washing the residual solids with a small amount of additional solvent may provide a suitable separation/recovery operation. Once the liquid extract has been separated from the solids, the residual solids are typically removed from the reactor prior to repeating the process. In some instances, however, the residual solid botanical material may be subjected to a second extraction operation. In yet others, the residual solid botanical material may be subjected to a second combined enzyme treatment/extraction operation. The extraction operation or combined enzyme treatment/extraction operation may be repeated multiple times on the same sample of botanical material. When the botanical solids are subjected to more than one extraction (or combined enzyme treatment/extraction operation), the extraction operations may be conducted in a countercurrent fashion, i.e., with the liquid extract from the most spent lot of solid material being used sequentially to extract the next most spent lot of solid material and so on.

The filtered extract may then be further concentrated by evaporating away a portion of the alcohol solution or diluted with additional water and/or alcohol, depending on the desired strength of the final extract. For example, the volume of solvent in the reactor may be increased by introducing additional water and/or alcohol into the reactor to provide a second aqueous alcohol solvent. The second aqueous alcohol solvent may have a different alcohol content than the original aqueous alcohol solvent and typically contains about 30 to 65 vol. % alcohol. If desired, the enzyme-treated vanilla beans can be subjected to additional extraction by contacting the beans with the second aqueous alcohol solvent. This would typically be carried out in the sealed reactor under conditions similar to the initial extraction operation. Dilution may take place during the extraction process by cooling the vanilla bean solution, opening the reactor, adding additional water and/or alcohol and resealing the reactor. Alternatively, dilution may take place during extraction without breaking the reactor seal by pumping the water and/or alcohol solution into the sealed reactor at a pressure that is the same as, or higher than the pressure inside the reactor. For example, additional water and/or alcohol may be added to the sealed reactor under conditions that do not increase the internal pressure in the reactor, e.g., by releasing some of the built up internal pressure in the reactor and introducing water and/or alcohol into the sealed reactor at a pressure that restores the internal reactor pressure. Dilution may also take place during the extraction process by cooling the vanilla bean solution sufficiently to reduce the internal pressure in the reactor somewhat (to a “reduced pressure” which may still be higher than ambient pressure), introducing additional water and/or alcohol into the sealed reactor in a manner which roughly maintains the reduced pressure and subsequently reheating the contents of the sealed reactor to generate a desired internal pressure and temperature.

The present methods are capable of producing natural vanilla extracts having a range folds (i.e., concentrations of extracted components), where a fold is a relative measure of strength of the vanilla extract under FDA regulations. A single fold vanilla extract contains the extracted matter from 13.35 ounces of vanilla beans, having no more than 25 wt. % water content (moisture), in one gallon of aqueous alcohol (which contains at least 35 vol. % alcohol). Preferably, the extracted matter from the vanilla beans is present as a solution in aqueous ethanol having an ethanol content of at least 35 vol. % ethanol. Aqueous vanilla extracts commonly have ethanol contents of about 40 to 60 vol. %, with the remaining material being water and extracted components. If desired, other food additives such as dextrose or glycerin may be added to the vanilla extract. A two fold vanilla extract contains twice as much extracted matter, that is, a two fold vanilla extract contains the extracted matter from 26.7 ounces of vanilla beans, having no more than 25 wt. % moisture, in one gallon of aqueous alcohol (containing at least 35 vol. % alcohol). Similarly, three fold, four fold and higher folds contain just three, four, etc. times the content of extracted matter of a single fold extract. The present methods may be used to produce single fold, two fold, three fold, four fold and higher fold vanilla extracts. It should be noted, however, that the natural vanilla extracts disclosed herein are not limited to those compositions that fall under the definition of “vanilla extract” under governmental regulations, but also cover natural vanilla extracts that fall outside of definitions provided by government regulations.

One general exemplary method for producing a natural vanilla extract is described as follows. A quantity of cured vanilla beans is placed into a suitable reactor fitted with a paddle or plow blade, such as a Littleford-Day DVT-130 Pressure/Vacuum Reactor. An aqueous alcohol solvent, such as a water/ethanol mixture, is then introduced to the reactor at ambient pressure and the reactor is sealed. The vanilla beans may be processed whole, but they may also desirably be chopped or ground prior to processing. For example, when whole cured vanilla beans are introduced into the reactor together with the aqueous solvent, the whole beans may be broken into pieces by the action of a plow blade or chopper blade used to agitate the mixture in the reactor. In some instances, it may be advantageous to agitate the mixture while the paddle/plow blade at a relatively high rate for an initial period of time to break up the beans, followed by a more gentle agitation during the remaining period of time that the enzyme treatment/extraction of the beans is carried out. As indicated herein, it is generally advantageous to break the beans into pieces while avoiding breaking the solid material down into a finer material which would be capable of absorbing larger quantities of liquid.

The sealed reactor is then heated to an elevated temperature, typically at least about 170° F. and, more commonly, about 190° F. to 220° F. Due to the vapor pressure of the solvent (typically an aqueous ethanol solvent), this generates a increased pressure in the reactor. For example, if the solvent is introduced into the reactor at ambient pressure, sealing the reactor and heating the contents to temperatures of 170° F. and above can generate a pressure which is greater than ambient pressure. If an aqueous alcohol solvent, such as aqueous ethanol or aqueous isopropanol is employed, heating the reactor contents to such temperatures can generate pressure of at least about 10 psig, although higher pressures may be used. For example, pressures of about 15 to about 30 psig can commonly be produced by heating aqueous ethanol solvents to temperatures of about 190° F. to 220° F. in a sealed reactor. If desired, higher pressures may be achieved by introducing the solvent into the reactor under pressure, e.g., as a result of introducing a high pressure stream of solvent and/or supplying a pressurized gas, such as nitrogen, into the head space of the reactor.

The solid material, e.g., chopped vanilla beans, is then incubated for a period of time, typically about one to two hours. Additional water, ethanol or a mixture of both may then be introduced into the reactor to produce a final desired ethanol concentration. Extraction may be continued for another period of time at this point, e.g., for about another hour. After cooling, the liquid extract is suitably discharged through a filter or sieve to separate the residual solids from the primary vanilla extract. Suitable filters include Filtorr® filters available from Littleford Day, Florence Ky. Suitable external sieves include filtrations units available from Sweco, Florence, Ky., and Sparkler Filters Inc., Conroe, Tex. The grade of filter aid of the filter or mesh of sieve may vary depending upon the desired clarity of the extract. The remaining beans are then removed from the reactor. Optionally, the primary extract may be processed to increase the fold concentration through vacuum evaporation, or diluted down to a lower fold extract. The total processing time for this method commonly requires no more than about 15 hours and may take 5 hours or less using production scale equipment.

Optionally, the vanilla beans may be treated with an enzyme material prior to extraction. For example, a quantity of vanilla beans may be charged into a suitable reactor along with an aqueous medium and a suitable quantity of enzymatic material, such as Depol 40L enzyme material from Biocatalysts, Wales, UK or Crystalzyme Concord enzyme material from Valley Research, Inc., South Bend, Ind. The reactor is then optionally pressurized with nitrogen, or another non-reactive gas, to an elevated pressure in order to force the enzymes into the vanilla matrix fibers. Pressures employed in the reactor during enzymatic treatment may reach about 80 psig or even greater. In other embodiments, the enzyme treatment may be conducted at the equilibrium pressure which results from heating the aqueous alcohol solvent in a sealed reaction vessel. The reactor is heated to a temperature suitable to facilitate enzymatic digestion of the beans, without de-naturing the enzymes. Typically, temperatures from about 120° F. to about 140° F. are considered suitable. The enzyme treatment continues for a period of time sufficient to allow the enzymes to at least partially break down the fiber matrix of the vanilla beans (typically about 0.5 to 3 hours). The pressure in the reactor is then released and additional alcohol (or aqueous alcohol) is then added to the enzyme treated vanilla beans. The treated beans are suitably incubated according to the extraction procedure described above, beginning with charging a water/ethanol mixture into the reactor When the enzymatic treatment step is included, the entire process may take no more than about 20 hours and, in many instances, may be completed in no more than about 10 hours (or less) from start to finish.

### EXAMPLES

Exemplary embodiments of the present methods for producing natural vanilla extracts are provided in the following examples. The following examples are presented to illustrate the methods and to assist one of ordinary skill in using the same. The examples are not intended in any way to otherwise limit the scope of the invention.

Equipment

The reactor used to produce the natural vanilla extracts in the examples below was a Littleford-Day Model DVT-130 Polyphase Pressure/Vacuum Reactor. This reactor has a 35 gallon total capacity (22.8 gallon working capacity) horizontal cylindrical tank made of 304 stainless steel construction with a charging port on the top, a bottom discharge port and a door on the side to discharge the spent beans. It has a 15 HP variable speed drive moving plow shaped mixing element that completely sweeps the inside surface of the reactor using a variable drive from 0-160 rpm, a 10 HP two speed high shear impact chopper running at 1800 and 3600 rpm, and a 100 psig heat transfer jacket heated by both generated hot water and steam. It has the capability of internal pressure up to 250 psig. It also has capacity for high vacuum service down to less than about 10 mm Hg, and can be fitted with a filter (Filtorr®) system at the discharge port with various mesh screens. Models are available up to 6,605 gallon total capacity.

### Example 1

### Preparation of 2.4 Fold Natural Vanilla Extract from Whole Madagascar Bourbon Vanilla Beans

A quantity of 12.33 kg whole Madagascar Bourbon Vanilla Beans, 21.8 kg water and 28.22 kg ethanol (95%) were charged into a Littleford Day DVT-130 reactor. The reactor jacket was sealed and heated to approximately 200° F. via steam injection into a water filled jacket and the vanilla beans were extracted for about one hour. A quantity of 6.2 kg water was then added to the reactor to bring the ethanol concentration down to about 50 vol. %. Extraction continued for an additional hour. The material in the reactor was then cooled to approximately 114° F., by pumping chilled water through the jacket. The extract was discharged through a 20-mesh Filtorr® screen on the bottom of the reactor, and into 5 gallon plastic buckets. About 44.0 kg of 2.4 Fold Vanilla Extract was recovered. The maximum temperature and pressure during the extraction process were 206° F. and 18 psig, respectively. The total processing time was 2 hours and 30 minutes.

A sample of the resulting extract was taken for analysis on HPLC and the results were as follows:

| | |
|---|---|
| p-hydroxybenzoic acid | 5.8 mg/100 ml |
| p-hydroxybenzaldehyde | 16.3 mg/100 ml |
| Vanillic acid | 28.2 mg/100 ml |
| Vanillin | 271.5 mg/100 ml |

### Example 2

### Preparation of 2.4 Fold Natural Vanilla Extract from Chopped Madagascar Bourbon Vanilla Beans I

A quantity of 12.4 kg whole Madagascar Bourbon Vanilla Beans was charged into the reactor and chopped for two minutes at half speed, followed by one minute at full speed. A quantity of 21.8 kg water and 28.2 kg ethanol (95%) were charged into a Littleford Day DVT-130 reactor. The reactor jacket was sealed and heated to approximately 190° F. via steam injection into a water filled jacket and the vanilla beans were extracted for about one hour. The contents of the reactor were cooled to about 130° F. and a quantity of 6.2 kg water was then added to the reactor to bring the ethanol concentration down to about 50 vol. %. The reactor was then heated again to about 190° F. and extraction continued for an additional hour. The material in the reactor was then cooled to approximately 130° F., by pumping chilled water through the jacket. The extract was discharged through a 30-mesh Filtorr® screen on the bottom of the reactor, and into 5 gallon plastic buckets. About 37.7 kg of 2.4 Fold Vanilla Extract was recovered. The maximum temperature and pressure during the extraction process were 199° F. and 18 psig, respectively. The total processing time was 2 hours and 33 minutes.

A sample of the resulting extract was taken for analysis on HPLC and the results were as follows:

| | |
|---|---|
| p-hydroxybenzoic acid | 4.1 mg/100 ml |
| p-hydroxybenzaldehyde | 18.7 mg/100 ml |
| Vanillic acid | 20.3 mg/100 ml |
| Vanillin | 291.8 mg/100 ml |

### Example 3

### Preparation of 2.4 Fold Natural Vanilla Extract from Chopped Madagascar Bourbon Vanilla Beans II

A quantity of 12.3 kg whole Madagascar Bourbon Vanilla Beans, 21.8 kg water and 28.2 kg ethanol (95%) were charged into a Littleford Day DVT-130 reactor. The chopper was run at full speed for one minute. The reactor jacket was sealed and heated to approximately 200° F. via steam injection into a water filled jacket and the vanilla beans were extracted for about one hour. The contents of the reactor were cooled to about 113° F. and a quantity of 6.2 kg water was then added to the reactor to bring the ethanol concentration down to about 50 vol. %. The reactor was then heated again to about 200° F. and extraction continued for an additional hour. The material in the reactor was then cooled to approximately 120° F., by pumping chilled water through the jacket. The extract was discharged through a 30-mesh Filtorr® screen on the bottom of the reactor, and into 5 gallon plastic buckets. About 38.6 kg of 2.4 Fold Vanilla Extract was recovered. The maximum temperature and pressure during the extraction process were 204° F. and 24 psig, respectively. The total processing time was 2 hours and 35 minutes.

### Example 4

### Preparation of 2.4 Fold Natural Vanilla Extract from Chopped Madagascar Bourbon Vanilla Beans with Enzymatic Treatment

A quantity of 12.3 kg whole Madagascar Bourbon Vanilla Beans, from the same batch as those in Example 3, 21.8 kg water and 250 g Crystalzyme Concord enzyme material (commercially available from Valley Research, Inc.) were charged into a Littleford Day DVT-130 reactor. The chopper was run for one minute at full speed. The reactor was then sealed and pressurized to 50 psig with nitrogen gas. Heated water was pumped into the reactor jacket to heat the reactor to an internal temperature of 130° F. for the enzyme incubation. Once temperature was reached the pressure was increased to 80 psig. The enzyme treatment was allowed to continue at 130° F. for 1 hour. The pressure was released and 28.2 kg of ethanol was charged to the reactor. The reactor jacket was sealed and heated to approximately 200° F. via steam injection into a water filled jacket and the vanilla beans were extracted for about one hour. The contents of the reactor were cooled to about 113° F. and a quantity of 6.2 kg water was then added to the reactor to bring the ethanol concentration down to about 50 vol. %. The reactor was heated again to about 200° F. and extraction continued for an additional hour. The material in the reactor was then cooled to approximately 113° F., by pumping chilled water through the jacket. The extract was discharged through a 30-mesh Filtorr® screen on the bottom of the reactor, and into 5 gallon plastic buckets. About 38.5 kg of 2.4 Fold Vanilla Extract was recovered. The maximum temperature and pressure during the enzyme treatment were 204° F. and 80 psig, respectively. The maximum pressure during the extraction period was 24 psig. The total processing time was 4 hours.

### Example 5

### Control Experiment—Preparation of 2.4 Fold Natural Vanilla Extract from Chopped Madagascar Bourbon Vanilla Beans with a Percolation Method

A quantity of 0.851 kg whole Madagascar Bourbon Vanilla Beans, from the same batch as those in Example 3, were milled down to provide ground beans having an average particle size of about ⅛ to 3/4 inch. The ground beans were manually placed in cheesecloth and bound forming a closed bag-like sack. The sack containing the ground beans was placed into a percolator and 1.504 kg water and 1.947 kg ethanol (95%) were charged into the percolator tank, making a 60 vol. % ethanol solution. The water/ethanol mixture was then circulated over the bag and heated to 130° F. The extraction was allowed to proceed for 24 hours at this temperature. Following this initial 24 hours, the extract solution was diluted to 50% ethanol by addition of water. The extraction liquor was reheated to 130° F. and the extraction process allowed to proceed for an additional 24 hours, for a total extraction time of 48 hours. After the second 24 hours, the extraction mixture was cooled to ambient temperature and drained. Approximately 2.76 kg of 2.4 Fold Vanilla Extract was recovered. The total processing time was approximately 52 hours.

### Example 6

### Preparation of 2.4 Fold Natural Vanilla Extract from Chopped Indonesian Vanilla Beans

A quantity of 12.3 kg whole Indonesian Vanilla Beans, 21.8 kg water and 28.2 kg ethanol (95%) were charged into a Littleford Day DVT-130 reactor. The chopper was run at full speed for one minute. The reactor jacket was sealed and heated to approximately 212° F. via steam injection into a water filled jacket and the vanilla beans were extracted for about one hour. The contents of the reactor were cooled to about 120° F. and a quantity of 6.2 kg water was added to the reactor to bring the ethanol concentration down to about 50 vol. %. The reactor was resealed and heated again to about 212° F. and extraction continued for an additional hour. The material in the reactor was then cooled to approximately 128° F., by pumping chilled water through the jacket. The extract was discharged through a 30-mesh Filtorr® screen on the bottom of the reactor, and into 5 gallon plastic buckets. About 33.8 kg of 2.4 Fold Vanilla Extract was recovered. The maximum temperature and pressure during the extraction process were 214° F. and 28 psig, respectively. The total processing time was 2 hours and 43 minutes.

A sample of the resulting extract was taken for analysis on HPLC and the results were as follows:

| | |
|---|---|
| p-hydroxybenzoic acid | 1.55 mg/100 ml |
| p-hydroxybenzaldehyde | 6.16 mg/100 ml |
| Vanillic acid | 1.25 mg/100 ml |
| Vanillin | 5.19 mg/100 ml |

### Example 7

### Preparation of 2.4 Fold Natural Vanilla Extract from Chopped Indonesian Vanilla Beans with Enzymatic Treatment

A quantity of 12.3 kg whole Indonesian Vanilla Beans, from the same batch as those in Example 6, 21.8 kg water and 250 g Crystalzyme Concord from Valley research were charged into the reactor. The chopper was run for two and a half minutes at full speed. The reactor was then sealed and pressurized to 80 psig with nitrogen gas. Heated water was pumped into the jacket to heat the reactor to an internal temperature of 130° F. for the enzyme incubation. The enzyme treatment was allowed to continue at 130° F. for 1 hour. The pressure was released and 28.2 kg of ethanol was charged to the reactor. The reactor jacket was sealed and heated to approximately 212° F. via steam injection into a water filled jacket and the vanilla beans were extracted for about one hour. The contents of the reactor were cooled to about 120° F. and a quantity of 6.2 kg water was then added to the reactor to bring the ethanol concentration down to about 50 vol. %. The reactor was then heated again to about 212° F. and extraction continued for an additional hour. The material in the reactor was then cooled to approximately 121° F., by pumping chilled water through the jacket. The extract was discharged through a 30-mesh Filtorr® screen on the bottom of the reactor, and into 5 gallon plastic buckets. About 14.5 kg of 2.4 Fold Vanilla Extract was recovered. The maximum temperature and pressure during the enzyme treatment were 214° F. and 80 psig, respectively. The maximum pressure during the extraction period was 27 psig. The total processing time was 4 hours and 27 minutes.

A sample of the resulting extract was taken for analysis on HPLC and the results were as follows:

| | |
|---|---|
| p-hydroxybenzoic acid | 1.25 mg/100 ml |
| p-hydroxybenzaldehyde | 6.63 mg/100 ml |
| Vanillic acid | 1.45 mg/100 ml |
| Vanillin | 5.46 mg/100 ml |

### Example 8

### Sensory Evaluation I

The three natural vanilla extracts produced in Examples 3-5 above were compared in an ice cream tasting, where the extract of Example 5 was used as a control. Each of the samples was placed in ice cream at a usage of 4 oz. per 10 gallons of ice cream mix. Additionally, the extracts from Example 3 (non-enzyme treated) and Example 4 (enzyme treated) were also sampled at 75% of the control usage and at 50% of the control usage.

The studied revealed that the extract of Example 3 more closely matched the control of Example 5 at the 75% usage rate than at the 50% usage rate. The enzyme treated vanilla of Example 4 more closely matched the control at 50% usage than at 75% usage.

### Example 9

### Sensory Evaluation II

A comparison of the natural vanilla extracts of Examples 4 and 5 was conducted. Example 5 was used as a control. For this study, samples of vanilla ice cream were made with the control extract (“Ice Cream A”) and with the vanilla extract of Example 4 (enzyme treated). Two ice cream samples were made with the extract from Example 4. In the first extract, the amount of vanilla extract from Example 4 was reduced by 50% with respect to the control extract (“Ice Cream B”). In the second sample the amount of vanilla extract from Example 4 was reduced by 45% with respect to the control extract (“Ice Cream C”).

A panel of 72 people evaluated the resulting ice creams. The ice creams were served cold as two oz. samples in Styrofoam cups. Each panelist tested four samples. The first sample was an identified control (Ice Cream A) and the remaining three samples were Ice Cream A, Ice Cream B and Ice Cream C, in random order with a complete block. The panelists rated the size of the difference in overall flavor of each sample including the blind control relative to the named identified control using a line scale of 0-9 anchored at 0=no difference and 9=extremely different.

The data was analyzed using a two-step procedure. First, an analysis of variance (ANOVA), was conducted to determine if there was any significant difference between the mean scores for the samples. ANOVA was carried out using Compusense 5 version 4.4 software from Compusense Inc. Next, having found that a significant difference existed, multiple comparison analysis was carried out, comparing two mean scores at a time to determine where the significant differences lie. The mean scores for each sample, as well as results of ANOVA and multiple comparison analyses are as shown in the results summary in Table 1 below.

TABLE 1

| | | | | | Ice | Ice | Ice |
|---|---|---|---|---|---|---|---|
| | | | | | Cream | Cream | Cream |
| | | | | | A | B | C |
| | F | p | HSD | LSD | Mean | Mean | Mean |
| | Value | Value | Value | Value | Score | Score | Score |
| Overall | 5.04 | 0.0077 | 0.8204 | 0.6837 | 2.46 | 3.47 | 2.61 |
| Flavor | | | | | | | |

Multiple Comparison Tests Used: Tukey's HSD 5% & Fisher's LSD 5%

The F value obtained from an ANOVA of the results of the sensory study was 5.04. Comparing this value to the values from statistical tables, it may be determined that the value exceeds the statistical values at 1% and 5% but not at 0.1%. Thus, the null hypothesis (i.e. the hypothesis that the differences between the different ice creams are not significant) may be rejected with a less than 1% chance of being wrong (i.e. p<0.01). In a second step, multiple comparison tests were used to determine which of the means were different. Tukey's HSD (honestly significant difference, more conservative) and Fisher's LSD (least significant difference, less conservative) multiple comparison tests were used to determine where differences between samples were as shown by ANOVA. The calculated HSD and LSD values are shown in Table 1. The differences between any two mean scores must exceed these values to be considered significant. As shown in Table 1, both multiple comparison tests show that there is a significant difference in overall flavor between Ice Cream B (Enzyme treated at 50% reduced usage) and Ice Creams A (Control) and C (Enzyme treated at 45% reduced usage). Ice Cream A and Ice Cream C are not significantly different, in other words they are at parity in overall flavor.

These results demonstrate that the vanilla extracts produced according to the methods provided herein may be used in amounts that are at least 45% lower than conventionally obtained vanilla extracts without any difference in overall flavor.

### Example 10

### Sensory Evaluation III

A comparison of the natural vanilla extracts of Examples 3 and 5 was conducted. Example 5 was used as a control. For this study, samples of vanilla ice cream were made with the control extract (“Ice Cream D”) and with the vanilla extract of Example 4 (non-enzyme treated). Two ice cream samples were made with the extract from Example 3. In the first extract, the amount of vanilla extract from Example 3 was reduced by 35% with respect to the control extract (“Ice Cream E”). In the second sample, the amount of vanilla extract from Example 3 was reduced by 25% with respect to the control extract (“Ice Cream F”).

A panel of 70 people evaluated the resulting ice creams. The ice creams were served cold as two oz. samples in Styrofoam cups. Each panelist tested four samples. The first sample was an identified control (Ice Cream D) and the remaining three samples were Ice Cream D, Ice Cream E and Ice Cream F, in random order with a complete block. The panelists rated the size of the difference in overall flavor of each sample including the blind control relative to the named identified control using a line scale of 0-9 anchored at 0=no difference and 9=extremely different.

The data was analyzed using the two-step procedure described above in Example 9. The mean scores for each sample, as well as results of ANOVA and multiple comparison analyses are as shown in the results summary in Table 2 below.

TABLE 2

| | | | | | Ice | Ice | Ice |
|---|---|---|---|---|---|---|---|
| | | | | | Cream | Cream | Cream |
| | | | | | D | E | F |
| | F | p | HSD | LSD | Mean | Mean | Mean |
| | Value | Value | Value | Value | Score | Score | Score |
| Overall | 0.03 | 0.9711 | 0.8778 | 0.7316 | 2.95 | 3.04 | 2.96 |
| Flavor | | | | | | | |

Multiple Comparison Tests Used: Tukey's HSD 5% & Fisher's LSD 5%

The F value obtained from an ANOVA of the results of the sensory study was 0.03. Comparing this value to the values from statistical tables, it may be determined that the value is lower than the values from the statistical tables at 0.1%, 1% and 5%. Thus, the null hypothesis (i.e. the hypothesis that the differences between the different ice creams are not significant) is upheld. Both multiple comparison tests (HSD and LSD) confirm that there is no significant difference in overall flavor between the samples. Thus, Ice Cream D, Ice Cream E and Ice Cream F are not significantly different, in other words they are at parity in overall flavor.

These results demonstrate that the vanilla extracts produced according to the methods provided herein may be used in amounts at least 35% lower than conventionally obtained vanilla extracts without any difference in overall flavor.

The methods provided herein may be further illustrated by the following, non-limiting embodiments.

A process is provided for producing a natural botanical extract. In a first exemplary embodiment, the process includes the step of contacting a comminuted botanical material with an aqueous alcohol solvent in a sealed reactor at an elevated temperature to produce a primary extract. In a second exemplary embodiment, the process includes the steps of treating a solid botanical material in an aqueous medium with an enzyme material having glycosidase activity and contacting the enzyme-treated botanical material with an aqueous alcohol solvent at a pressure of at least about 10 psig and a temperature of at least about 170° F. (˜77° C.) to provide a primary extract.

In one illustrative embodiment, the process is used to produce a natural vanilla extract. This process includes the step of contacting comminuted, cured vanilla beans with an aqueous alcohol solvent in a sealed reactor to provide a primary vanilla extract. More particularly, the process may include the step of agitating a slurry which includes comminuted, cured vanilla beans and an aqueous alcohol solvent in a sealed reactor to provide a primary vanilla extract. In this embodiment the pressure in the sealed reactor is at least about 10 psig, the temperature in the reactor is about 170 to 250° F. and the alcohol content in the alcohol solvent is about 30 to 65 vol. % alcohol. Ethanol is one non-limiting example of a suitable alcohol for use in the aqueous alcohol solvent. In some instances, the pressure in the sealed reactor may be about 10 to 100 psig. Typically, the comminuted vanilla beans will have an average particle size of about ⅛ to 3/4 inch, although other average particle sizes are possible. The vanilla beans and the aqueous alcohol solvent should be contacted for a time sufficient to produce a primary extract, in some instances this may be accomplished by contacting the vanilla beans and the aqueous alcohol solvent in the sealed reactor for about 0.5 to 5 hours. Generally, the primary extract produced according to this illustrative embodiment will have a pH of about 4.5 to 6.0. In one specific example, the aqueous alcohol solvent contains at least about 35 vol. % ethanol; the comminuted, cured vanilla beans have a water content of no more than about 25 wt. %; and the slurry containing the vanilla beans and the aqueous alcohol solvent contains no more than about 1.0 gallons of the aqueous alcohol solvent per 13.35 ounces of the comminuted, cured vanilla beans. In still another specific example, the aqueous alcohol solvent contains at least about 35 vol. % ethanol; the comminuted, cured vanilla beans have a water content of no more than about 25 wt. %; and the slurry containing the vanilla beans and the aqueous alcohol solvent contains no more than about 0.5 gallons of the aqueous alcohol solvent per 13.35 ounces of the comminuted, cured vanilla beans.

In another illustrative embodiment, the process is used to produce a natural vanilla extract. This process includes the steps of treating cured vanilla beans in an aqueous medium with an enzyme material having glycosidase activity and incubating the enzyme-treated vanilla beans in an aqueous alcohol solvent at a pressure of at least about 10 psig and a temperature of at least about 170° F. to provide a primary vanilla extract. In this process, the cured vanilla beans may be treated with the enzyme material at elevated temperatures of up to and including about 180° F. For example, the enzyme treatment may take place at about 100 to 140° F. The enzyme treatment may be relatively short-lived, for example, in some embodiments the enzyme treatment may last no more than about 2 hours (e.g. from about 0.25 to 2 hours). The enzyme treatment step may optionally be carried out under a pressure of at least about 50 psig (e.g. from about 10 to 50 psig) and may be carried out under an inert gas atmosphere. The glycosidase activity of the enzyme material may include a cellulase activity, a hemicellulase activity, a xylanase activity, a pectinase activity, a glucosidase activity or a combination thereof. In some instances, the extraction temperature is in the range of 180 to 250° F. The extraction period may also be relatively short. For example, the vanilla beans in the aqueous solvent may be extracted for a period of about 0.5 to 5 hours. The alcohol content of the alcohol solvent may be in the range of about 30 to 80 vol. %. Ethanol is a desirable solvent, however, the alcohol solvent may also desirably include isopropanol or mixtures of ethanol and isopropanol. The process may optionally include the step of evaporating a portion of the aqueous alcohol solvent in the primary extract to provide a concentrated extract. Alternatively, the process may optionally include the step of adding additional solvent to the primary extract to provide a diluted extract. The additional solvent may include water, alcohol or a mixture of water and alcohol. Also provided are vanilla extracts produced in accordance with the processing steps and conditions outlined above. Such extracts may include single and higher fold extracts.

In yet another illustrative embodiment, a natural vanilla extract is produced according to the following steps: treating cured vanilla beans in an aqueous medium with an enzyme material having a glycosidase activity in a reactor; introducing alcohol into the reactor at ambient pressure to provide an aqueous alcohol solvent, wherein the aqueous alcohol solvent comprises about 30 to 80 vol. % alcohol; sealing the reactor containing the aqueous alcohol solvent and the enzyme-treated vanilla beans under ambient pressure; and incubating the enzyme-treated vanilla beans and the aqueous alcohol solvent in the sealed reactor at a temperature of at least about 170° C. to provide a primary extract. In one variation of the process, whole cured vanilla beans are introduced into the reactor with the aqueous medium to form a slurry and the step of treating the vanilla beans with the enzyme materials includes agitating the slurry with a plow or stirring blade such that the whole cured vanilla beans are comminuted into smaller particles. The comminuted vanilla beans may also be agitated in the aqueous alcohol solvent during the extraction step to provide the primary extract. The agitation may be continuous. The comminuted vanilla beans will desirably have an average particle size of about ⅛ to 3/8 inch. In this process, the aqueous medium desirably includes no more than about 1.0 vol. % alcohol and/or desirably has a pH of about 4.5 to 6.0. The alcohol content of the aqueous alcohol solvent may be in the range of about 30 to 80 vol. %. Ethanol is a desirable solvent, however, the alcohol solvent may also desirably include isopropanol or mixtures of ethanol and isopropanol. The pH of the aqueous alcohol solvent is desirably from about 4.5 to 6.0. The process may optionally include the step of separating the primary extract from the enzyme-treated vanilla beans under ambient pressure. In some embodiments, the pressure in the sealed reactor containing the enzyme-treated vanilla beans and the aqueous alcohol solvent may be about 180 to 250° F. and the pressure may be about 10 to 100 psig. Also provided are vanilla extracts produced in accordance with the processing steps and conditions outlined above. Such extracts may include single and higher fold extracts.

Still another illustrative embodiment of a process for producing a natural vanilla extract includes the steps of treating cured vanilla beans in an aqueous medium with an enzyme material having glycosidase activity in a reactor, wherein the aqueous medium includes no more than about 10 vol. % alcohol, introducing alcohol into the reactor at ambient pressure to provide an aqueous alcohol solvent, wherein the aqueous alcohol solvent comprises about 30 to 80 vol. % alcohol, sealing the reactor containing a slurry including the aqueous alcohol solvent and enzyme-treated vanilla beans under ambient pressure, and agitating the slurry in the sealed reactor at a temperature of about 180 to 250° F. to provide a primary extract. In some embodiments, the enzyme treatment is carried out at a temperature of about 100 to 150° F. In some instances, the pressure in the sealed reactor may reach about 10 to 60 psig. The pH of both the aqueous medium and the aqueous alcohol solvent is desirably about 4.5 and 6.0. Also provided are vanilla extracts produced in accordance with the processing steps and conditions outlined above. Such extracts may include single and higher fold extracts.

The invention has been described with reference to specific and illustrative embodiments. However, it should be understood that many variations and modifications may be made while remaining within the spirit and scope of the invention.

1. A process for producing a natural vanilla extract comprising:
(a) treating cured vanilla beans in an aqueous medium with an enzyme material having glycosidase activity; and
(b) contacting the enzyme-treated vanilla beans with an aqueous alcohol solvent at a pressure of at least about 10 psig and a temperature of at least about 170° F. to provide a primary extract.

2. The process of claim 1, comprising treating the cured vanilla beans with the enzyme material at a temperature of no more than about 180° F.

3. The process of claim 2, comprising treating the cured vanilla beans with the enzyme material at about 70 to 180° F. for about 0.25 to 2 hours.

4. The process of claim 1, comprising treating the cured vanilla beans with the enzyme material under a pressure of at least about 50 psig.

5. The process of claim 4, comprising treating the cured vanilla beans with the enzyme material under an inert gas atmosphere.

6. The process of claim 1, comprising extracting the enzyme-treated vanilla beans in the alcohol solution under a pressure of about 10 to 60 psig.

7. The process of claim 1, comprising extracting the enzyme-treated vanilla beans in the aqueous alcohol solvent at about 180 to 250° F.

8. The process of claim 1 wherein the natural vanilla extract is at least a single fold vanilla extract.

9. The process of claim 1 wherein the aqueous alcohol solvent is an aqueous solution comprising ethanol.

10. The process of claim 9 wherein the aqueous alcohol solvent includes about 30 to 65 vol. % ethanol.

11. The process of claim 1 wherein the aqueous alcohol solvent includes ethanol, isopropanol or a mixture thereof.

12. The process of claim 1 wherein the aqueous alcohol solvent includes about 30 to 65 vol. % alcohol.

13. The process of claim 1, further comprising removing a portion of the aqueous alcohol solvent in the primary extract to provide a concentrated extract.

14. The process of claim 1, further comprising adding water, alcohol or a mixture thereof to the primary extract to provide a diluted extract.

15. The process of claim 14 wherein the additional solvent comprises water, alcohol, corn syrup, glycerin, propylene glycol, sucrose or a mixture thereof.

16. The process of claim 1 wherein the enzyme material comprises cellulase activity, hemicellulase activity, xylanase activity, pectinase activity or a combination thereof.

17. The process of claim 1 wherein the enzyme material comprises glucosidase activity.

18. The process of claim 1 wherein the enzyme material comprises β-glycosidase activity.

19. The process of claim 1 wherein the enzyme material comprises cellulase activity, hemicellulase activity, pectinase activity and glucosidase activity.

20. The process of claim 1 wherein the enzyme material comprises cellulase activity, pectinase activity, xylanase activity and β-glucosidase activity.

21. The process of claim 1 wherein the aqueous alcohol solvent comprises at least about 35 vol. % ethanol; the cured vanilla beans have a water content of no more than about 25 wt. %; and the contacting step comprises contacting the enzyme-treated vanilla beans and the aqueous alcohol solvent in a slurry containing no more than about 1.0 gallons of the aqueous alcohol solvent per 13.35 ounces of the cured vanilla beans employed in the treating step.

22. A vanilla extract produced by the process of claim 1.

23. The vanilla extract of claim 22 wherein said vanilla extract is at least a single fold vanilla extract.

24. A process for producing a natural vanilla extract comprising:
(a) treating cured vanilla beans in an aqueous medium with an enzyme material having glycosidase activity in a reactor;
(b) introducing a second solvent comprising alcohol into the reactor at ambient pressure to provide an aqueous alcohol solvent, wherein the aqueous alcohol solvent comprises about 30 to 65 vol. % alcohol;
(c) sealing the reactor including the aqueous alcohol solvent and enzyme-treated vanilla beans under ambient pressure; and
(d) contacting the enzyme-treated vanilla beans with the aqueous alcohol solvent in the sealed reactor at a temperature of at least about 170° F. to provide a primary extract.

25. The process of claim 24, further comprising introducing whole cured vanilla beans into the reactor with the aqueous medium and the enzyme material to form a slurry;
wherein the step of treating includes agitating the slurry with a plow or chopping blade such that the whole cured vanilla beans are comminuted into smaller particles.

26. The process of claim 24 wherein the aqueous medium includes no more than about 10 vol. % alcohol.

27. The process of claim 24 wherein the aqueous medium includes no more than about 1.0 vol. % alcohol.

28. The process of claim 24 wherein the aqueous medium has a pH of about 4.5 to 6.0.

29. The process of claim 24 wherein the aqueous alcohol solvent includes about 40 to 65 vol. % ethanol.

30. The process of claim 24, further comprising separating the primary extract from the enzyme-treated vanilla beans under ambient pressure.

31. The process of claim 24 wherein contacting the enzyme-treated vanilla beans with the aqueous alcohol solvent comprises agitating a slurry of comminuted enzyme-treated vanilla beans in the aqueous alcohol solvent to provide the primary extract.

32. The process of claim 31 wherein the comminuted enzyme-treated vanilla beans have an average particle size of about ⅛ to 1.5 inch.

33. The process of claim 31, comprising continuously agitating the slurry of the comminuted enzyme-treated vanilla beans in the aqueous alcohol solvent.

34. The process of claim 24, comprising contacting the enzyme-treated vanilla beans with the aqueous alcohol solvent in the sealed reactor at a pressure of at least about 10 psig to provide the primary extract

35. The process of claim 34, comprising contacting the enzyme-treated vanilla beans with the aqueous alcohol solvent in the sealed reactor at a temperature of about 180 to 220° F. and a pressure of about 10 to 60 psig to provide the primary extract.

36. The process of claim 24 wherein the aqueous alcohol solvent has a pH of about 4.5 to 6.0.

37. The process of claim 24 wherein the alcohol is ethanol, isopropanol or a mixture thereof.

38. The process of claim 24, further comprising diluting the aqueous alcohol solvent in the reactor by introducing additional water into the reactor.

39. The process of claim 38 wherein introducing the additional water comprises introducing the water into the sealed reactor under conditions that do not increase the pressure in the reactor.

40. The process of claim 38 wherein introducing the additional water comprises cooling the contents of the sealed reactor, opening the cooled reactor, adding the additional water to cooled reactor and resealing the reactor.

41. The process of claim 24 wherein the second solvent is an aqueous ethanol solution which contains at least about 70 wt. % ethanol.

42. A process for producing a natural botanical extract comprising:
(a) treating a solid botanical material in an aqueous medium with an enzyme material having glycosidase activity; and
(b) contacting the enzyme-treated botanical material with an aqueous alcohol solvent at a pressure of at least about 10 psig and a temperature of at least about 170° F. to provide a primary extract.

43. A process for producing a natural vanilla extract comprising:
(a) treating cured vanilla beans in an aqueous medium with an enzyme material having glycosidase activity in a reactor, wherein the aqueous medium includes no more than about 10 vol. % alcohol;
(b) introducing alcohol into the reactor at ambient pressure to provide an aqueous alcohol solvent, wherein the aqueous alcohol solvent comprises about 30 to 65 vol. % alcohol;
(c) sealing the reactor containing a slurry including the aqueous alcohol solvent and enzyme-treated vanilla beans under ambient pressure; and
(d) agitating the slurry in the sealed reactor at a temperature of about 180 to 250° F. to provide a primary extract.

44. The process of claim 43 wherein the cured vanilla beans are treated in an aqueous medium at a temperature of about 100 to 150° F.

45. The process of claim 43 wherein the slurry in the sealed reactor is agitated at a pressure of about 10 to 100 psig.

46. The process of claim 43 wherein the cured vanilla beans are treated in an aqueous medium having a pH of about 4.5 to 6.0 and the aqueous alcohol solvent in the slurry has a pH of about 4.5 to 6.0.

47. The process of claim 43, comprising treating the cured vanilla beans with the enzyme material for no more than about 2 hours.

48. The process of claim 43, comprising agitating the slurry in the sealed reactor for about 0.5 to 5 hours.
